(19) United States
(12) Patent Application Publication
(10) Pub. No.: US 2024/0055150 A1
(43) Pub. Date: Feb. 15, 2024

(54) RAPID NANOAPERTURE OPTICAL TRAPPING OF PROTEINS AND BIOMOLECULES BY FRINGE ELECTRIC FIELD

(71) Applicants: Reuven Gordon, Victoria (CA); Elham Babaei, Victoria (CA); Demelza Wright, Victoria (CA)

(72) Inventors: Reuven Gordon, Victoria (CA); Elham Babaei, Victoria (CA); Demelza Wright, Victoria (CA)

(21) Appl. No.: 18/449,546

(22) Filed: Aug. 14, 2023

Related U.S. Application Data
(60) Provisional application No. 63/397,779, filed on Aug. 12, 2022.

(51) Int. Cl. G21K 1/00

(52) U.S. Cl. CPC G21K 1/006

(57) ABSTRACT

Single molecule analysis of small proteins in aqueous environment without modifications (e.g., labels, tethers) elucidates their biophysics and interactions relevant to drug discovery. By fringe-field dielectrophoresis we demonstrate an order of magnitude speed up in nanoaperture optical tweezers for analyzing proteins below 5 kDa in solution, quantifying size and shape.

### CROSS REFERENCE TO RELATED APPLICATION

The present application claims the benefit of U.S. Provisional Application No. 63/397,779, filed Aug. 12, 2022, which is incorporated herein by reference in its entirety.

### FIELD

The disclosure pertains to optical trapping.

### BACKGROUND

Single-molecule techniques can resolve heterogeneity in behavior and give access to kinetics without synchronization. Ideally these methods would allow for seeing dynamics at a rapid timescale without modifications to a protein of interest in a physiological environment and applicable to both small and large biomolecules. While used extensively in free-solution studies, modifications like labelling and tethering disrupt the natural function of biomolecules with significant impact on properties such as diffusion, surface potential and binding kinetics. Techniques based on nanoaperture optical tweezers have been used for but are associated with long trapping times and significant delays (up to hours) in trapping. In techniques using dielectrophoresis, a counter electrode is placed in a solution containing particle to be trapped and a balance between electro-osmotic and electrothermophoretic forces can be achieved to trap labelled proteins by passing a laser beam through an array of nanoholes. In other approaches, a concentric array of nanoholes is used or an array of holes configured to produce local maximum plasmonic fields. These techniques generally require labeled particles or exhibit long trapping times. Improved approaches are needed.

### SUMMARY

Shaped nanoaperture based optical tweezers are configured so that an aperture in a conductive layer is used to enhance a field gradient, but also serves to produce a fringe field in an electrode that can be used to attract nanoparticles by dielectrophoresis. In some examples, a second electrode is placed on the other side of the metal film defining the aperture to produce a fringe field at the aperture with a gradient that increasing towards the aperture. Placing an electrode in the solution with the nanoparticles to be trapped produces an electric field that repels particles in contrast to the fringe fields applied with the disclosed electrodes.

The foregoing and other features, and advantages of the disclosure will become more apparent from the following detailed description, which proceeds with reference to the accompanying figures.

### BRIEF DESCRIPTION OF THE DRAWINGS

FIG. 1A illustrates a DEP enhanced double nanohole trapping apparatus that includes an external electrode.

FIG. 1B illustrates a sample region, application of an external field, and equipotential lines in the apparatus of FIG. 1A.

FIG. 1C illustrates typical trapping signals obtained for aprotinin (6.5 kDa).

FIG. 1D illustrates trapping times with no, AC, or DC voltages applied for various proteins.

FIG. 2A illustrates autocorrelation signals for neuropeptide Y, ovalbumin and conalbumin, with all fit to a biexponential function.

FIG. 2B illustrate a −2/3 power dependence of the autocorrelation time seen on log-log plot.

FIGS. 3A-3C illustrate trapping events for the proteins neuropeptide ovaibumin, and conalbumin, respectively.

FIGS. 4A-4B are graphs of average time-to-trap versus applied DC and AC voltages for different proteins (FIG. 4A) and for ovalbumin protein using the dielectrophoresis method (applied DC voltage) (FIG. 4B).

FIGS. 5A-5B illustrate calculated electrical potential in a plane through double nanoholes (DNHs) and perpendicular to the conductive layer used to define the DNHs with a second electrode outside of a particle solution.

FIGS. 6A-6B illustrated calculated electrical potential in a plane through DNHs and perpendicular to the conductive layer used to define the DNHs with a second electrode in a particle solution.

FIG. 7 is an SEM photograph of a representative DNH.

### DETAILED DESCRIPTION

### Introduction

As disclosed herein, AC and/or DC voltages are applied to generate a field gradient for a dielectrophoresis effect in double nanohole (DNH) optical trapping. In some examples, a counter electrode is situated on a side of a substrate opposite a side used to define DNHs, permitting rapid, label-free trapping of particles and proteins at least as small as 4 kDa. In the disclosed approaches, an electric field is provided that fringes through an aperture and attracts particles to the aperture by dielectrophoresis (DEP). To create a fringe field at the aperture with gradient increasing towards the aperture, a reference electrode can be placed on the opposite side of a metal film containing the apertures, away from the protein-containing solution.

### General Terminology

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

In some examples, values, procedures, or apparatus are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

### EXAMPLES

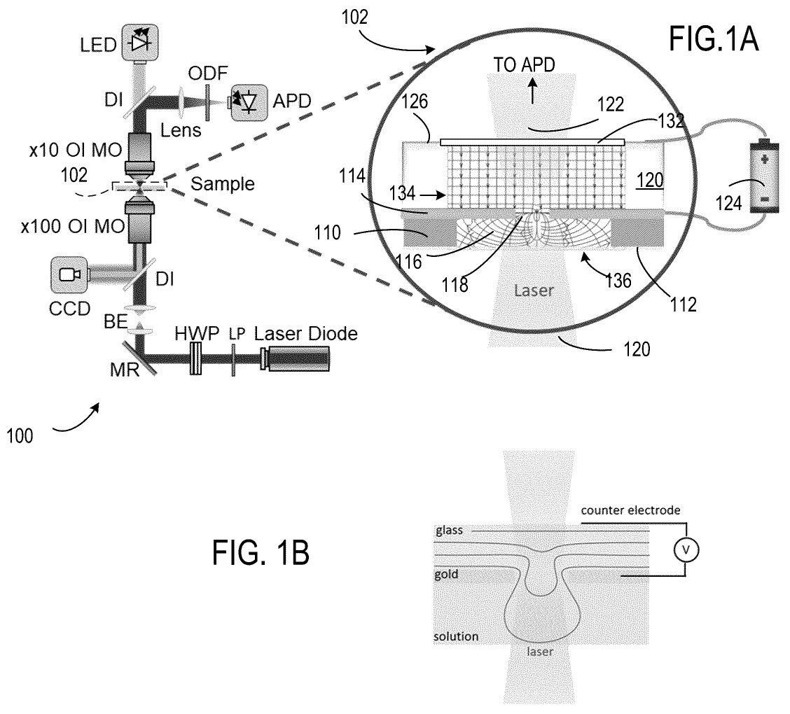

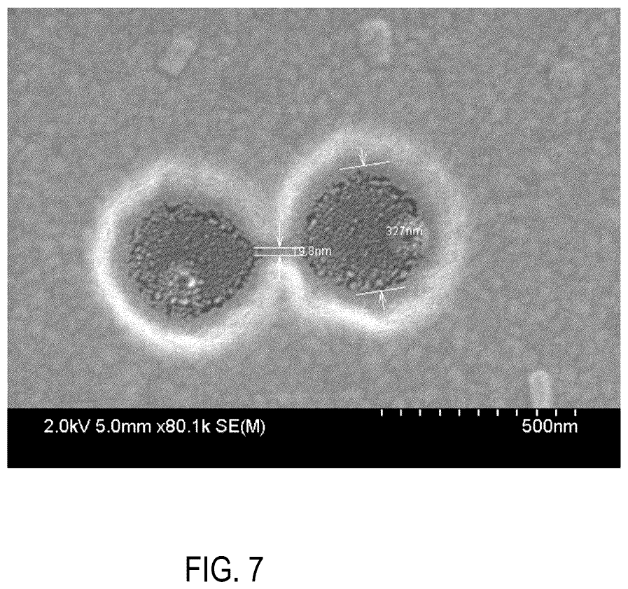

FIG. 1A illustrates an optical tweezer apparatus 100; FIG. 1B illustrates a double nanohole (DNH) assembly 102 of the optical tweezer apparatus 100. As shown in FIG. 1A, the DNH assembly 102 includes a spacer 110, a transparent cover 112 such as a glass slide or cover slip, and a gold layer 114 that define a sample volume 116. FIG. 7 shows a representative DNH. The gold layer 114 can be provided as a gold film on a glass or other transparent substrate such as a glass slide 120 and a DNH (or other aperture or apertures) defined in the gold layer 114. A sample such as a protein containing solution can be situated in the sample volume 116. A laser beam 120 is directed to the DNH assembly 102 and the DNH and a transmitted portion 122 is directed to an avalanche photodiode (APD) or other detector. A voltage source 124 such as a power supply or battery is electrically coupled to the gold layer 114 and an exit surface 126 of the glass slide 120 to provide an AC or DC voltage, or a voltage having both AC and DC components. As shown, a conductive layer 132 is situated at the exit surface 126 and serves as an electrode (along with the gold layer 114) for application of an electric field 134 that produces a fringe field shown as 136 that serves to attract nanoparticles to the aperture defined in the gold layer by virtue of the gradient of the electric field 114. The conductive layer can be a metallic layer, a transparent conductive coating, and can be provided with an aperture to permit transmission of optical beams.

FIG. 1C shows APD signals associated with typical trapping events for proteins as indicated by changes in the laser beam transmission through the DNH with a voltage applied as shown in FIG. 1B which shows equipotential lines for such a configuration. Trapping was repeated several times on each protein. The time to trap over repeated measurements is seen to be generally between 0 and 100 seconds when applying a DC bias value between 75 mV and 1.2 V, as shown in FIG. 1D. By comparison, similar trapping without the applied bias generally requires 400-500 seconds as shown in FIG. 1D which also shows trapping times with an applied AC voltage, which can be similar to that obtained with a DC voltage or, in some cases, more similar to trapping times. Thus, application of a voltage bias can provide an order of magnitude improvement in a time to trap. Other electrode configurations and not just the gold layer and the exit surface can be used, and an applied voltage can be an AC voltage.

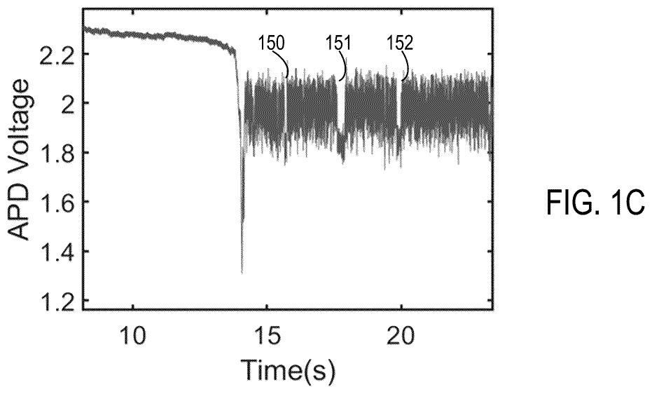

FIGS. 2A-2B illustrate analysis of proteins based on Brownian Motion using the arrangement of FIGS. 1A-1AA. FIG. 2A illustrates autocorrelation signals for neuropeptide Y, ovalbumin and conalbumin, with all fit to a biexponential function. FIG. 2B illustrates an approximately −2/3 power dependence of the autocorrelation time seen on log-log plot.

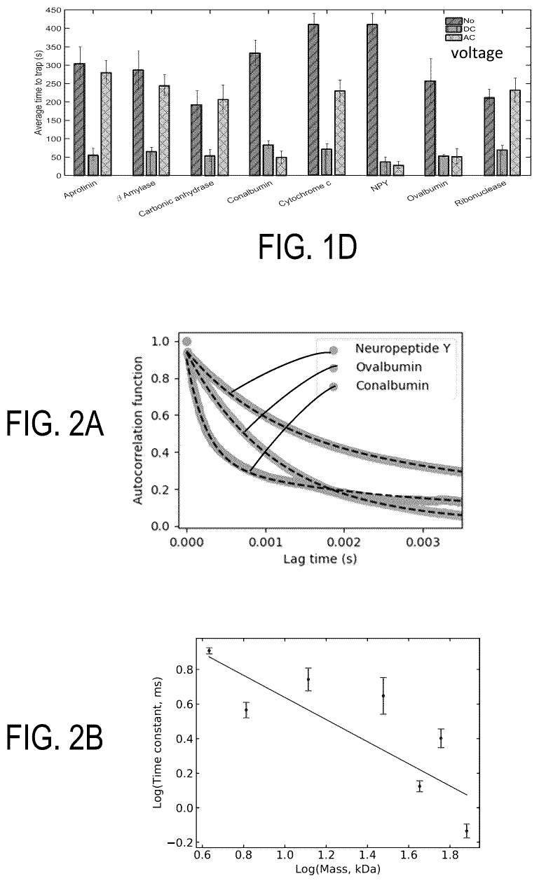

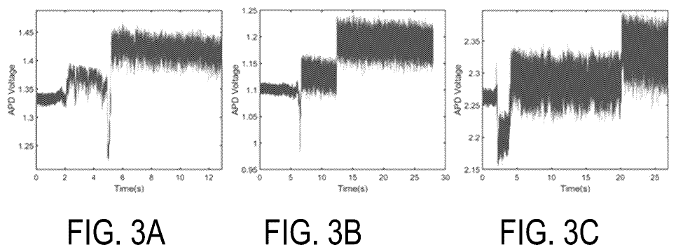

Trapping events using trapping systems as disclosed above for the proteins neuropeptide Y, ovalbumin, and conalbumin are shown in FIGS. 3A, 3B, and 3C, respectively.

FIG. 2A shows that all proteins have a fast time constant in the range of 0.4-3 ms. This was repeated consistently for multiple trapping events on each protein. As found previously, the short time constant scaled approximately with an exponent of −2/3 with the mass, as shown in FIG. 2B. As found previously, it is expected that the root mean square deviation scales linearly with mass. The precision compares favorably with recent scattered light results where 60% precision error was seen for a 9 kDa protein.

As was done previously for nanowires in conventional optical tweezers, the two timescales (biexponential) can be attributed to differences in transverse and longitudinal motion in the trap. Since the rotational drag is orders of magnitude smaller, this is expected to occur on a much faster time scale and can be neglected in this analysis, so the slow time constant corresponds to increased drag and decreased stiffness for motion normal to the long axis. Based on past reports, neuropeptide Y is red-shaped. From these two time constants the aspect ratio can be estimated.

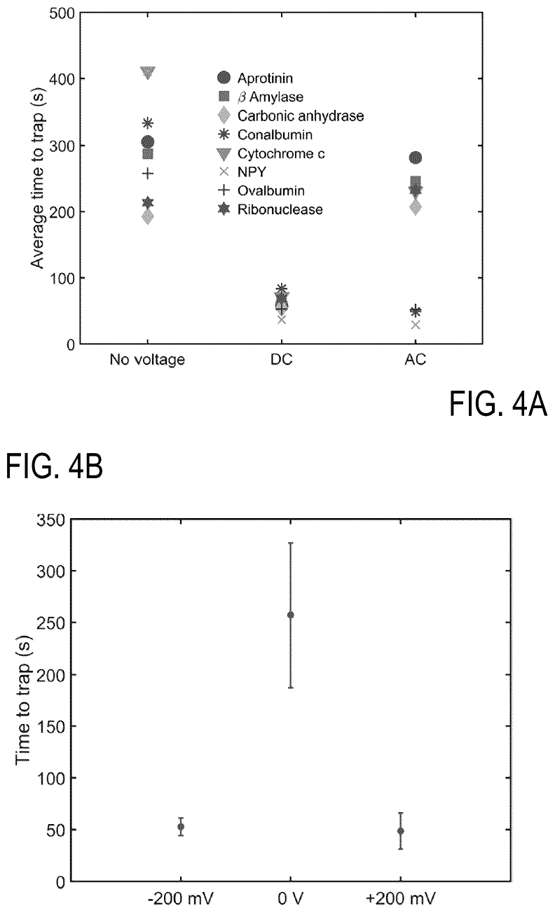

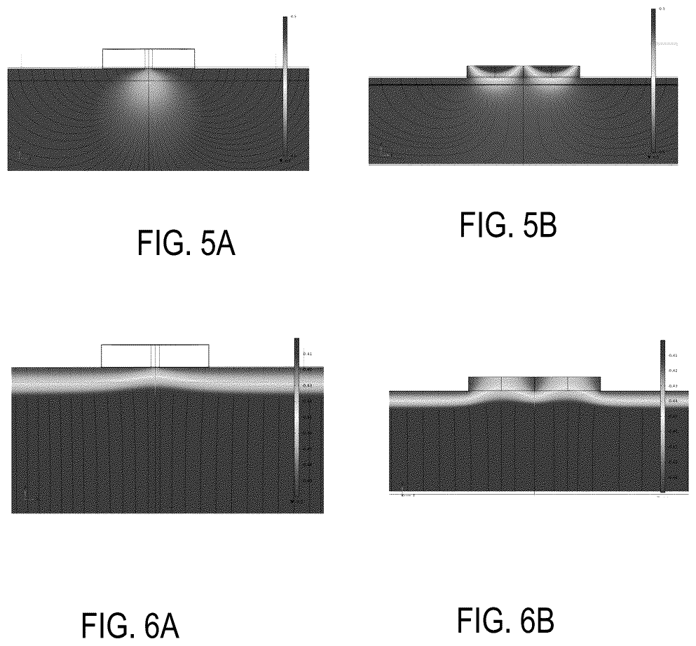

FIGS. 5A-5B and 6A-6B illustrate calculated electrical potentials with a reference or counter electrode out of the particle solution (FIGS. 5A-5B) and in the particle solution (FIGS. 6AS-6B). In the calculations, the double nanohole aperture had a radius of 165 nm and cusp size of 20 nm and was defined in a 70 nm thick gold film. The gold film was between water at the bottom and glass at the top and the voltage of the gold was set to −0.5 V and the counter electrode to 0 V.

### Example

An optical tweezer setup included an 850 nm laser diode. The polarization of the laser was aligned to give a minimum in transmission, corresponding to the polarization along the cusps of the DNH for this wavelength and geometry. The laser power was maintained at 16 mW. Trapping events for the proteins neuropeptide Y, ovalbumin, and conalbumin are shown in FIGS. 3A, 3B, and 3C, respectively.

A DC voltage of between 75 mV and 1.2 V was applied with a reference electrode reference outside of the particle containing solution. Placing the reference electrode in the solution appears to increase trapping times longer. Placing the reference electrode on the other side of the microslide (outside of the well) forms a fringe field in the solution region around the trap, attracting particles or proteins to the traps. It may be that dielectrophoresis (DEP) is effective because proteins are highly polarizable due to surface water interactions. Both positive and negative voltages work for trapping, proving that this was dielectrophoresis and not electrophoresis. While DC voltages were used, AC voltages at suitable frequencies can also be used.

The Brownian motion of the protein in the trap produces fluctuations in light transmitted through the DNH, which in turn can give information about the size and shape of the particle. Two metrics have been used to size the particle: the autocorrelation decay time, which scales as the −2/3 of the molecular weight; and root mean square deviation, which scales linearly. It has been shown that when multiple time constants are present, the faster time constant gives the motion of the particle that is related to size due to center of mass motion.

In summary, the disclosed systems and methods enable rapid trapping and analysis of unmodified single proteins in solution, even those below 4 kDa. The trapping approach also gives information about the protein shape by analyzing the characteristic times associated with motion in different directions. Since modifying proteins leads to changes in their biophysics, this approach can provide valuable biophysical data on unmodified proteins and their interactions in their natural environment. This approach is particularly promising considering the growing interest in understudied small proteins (<10 kDa), and the approach can provide rapid, label-free trapping.

In view of the many possible embodiments to which the principles of the disclosed technology may be applied, it should be recognized that the illustrated embodiments are only preferred examples and should not be taken as limiting the scope of the disclosure.

We claim:

1. An optical tweezer apparatus, comprising:
a shaped nanoaperture defined in a conductive layer; and
an electrode situated to produce a fringe field that attracts nanoparticles to the shaped nanoaperture.

2. The apparatus of claim 1, further comprising a voltage source coupled to electrode and the conductive layer defining the shaped nanoaperture to produce the fringe field.

3. The apparatus of any claim 1, wherein the conductive layer is a metallic layer.

4. The apparatus of claim 1, wherein the fringe field attracts the nanoparticles by dielectrophoresis.

5. The apparatus of claim 1, wherein the conductive layer is situated on a first surface of transparent substrate and the electrode is situated at a second surface of the transparent substrate, opposite the first surface.

6. The apparatus of claim 5, further comprising a spacer situated at the conductive layer on the first surface of the substrate, wherein the spacer defines a sample volume.

7. The apparatus of claim 2, wherein the voltage source is operable to provide one or both of a DC voltage and an AC voltage.

8. The apparatus of claim 1, wherein the shaped nanoaperture is a double nanohole.

9. The apparatus of any claim 1, further comprising a specimen volume defined by a spacer and the conductive layer and operable to retains a fluid specimen, wherein the fluid specimen includes one or more of:
proteins in a size range from 0.5 nm to 10 nm;
dsDNA or ssDNA, in a size range from 0.5 nm to 100 nm;
nanoscale biomaterials such as a lipoproteins or hormones; and
colloidal nanoparticles, quantum dots, nanoflakes, or nonlinear optical particles.

10. The apparatus of any claim 1, further comprising:
a laser situated to direct an input optical beam to the shaped nanoaperture; and
a detector situated to receive an optical beam indicative of trapping at the shaped nanoaperture in response to the input optical beam.

11. The apparatus of claim 10, wherein the received optical beam is a reflected optical beam.

12. The apparatus of claim 10, wherein the received optical beam is a transmitted optical beam.

13. A method, comprising:
situating a fluid specimen at a shaped nanoaperture;
applying an electric field to attract nanoparticles in the fluid specimen to the shaped nanoaperture; and
trapping at least one nanoparticle at the shaped nanoaperture with an optical beam.

14. The method of claim 13, wherein the applied electric field is a fringe electric field.

15. The method of claim 13, wherein the shaped nanoaperture is defined in a conductive layer situated at a first surface of transparent substrate and the electric field is applied by electrically coupling a voltage source to the conductive layer and to an electrode situated at a second surface of the transparent substrate, opposite the first surface.

16. The method of claim 13, wherein trapping of at least one nanoparticle is determined based on an optical beam reflected by or transmitted through the shaped nanoaperture.

17. The method of claim 13 wherein the shaped nanoaperture is a double nanohole.

18. The method of claim 13, wherein the electric field at the shaped nanoaperture has a field gradient having a magnitude that increases towards the shaped nanoaperture.

19. The method of claim 13, wherein the electric field is selected to reduce a trapping time.

20. The method of claim 13 wherein the electric field is selected to produce a dielectrophoretic force that reduces a trapping time.
